(19) United States
(12) Patent Application Publication
(10) Pub. No.: US 2009/0065085 A1
(43) Pub. Date: Mar. 12, 2009

(54) COMPRESSED-AIR BRAKE LINE

(75) Inventors: Andreas Dowe, Borken (DE); Micheal Boer, Olfen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/280,243

(22) PCT Filed: Sep. 10, 2007
(86) PCT No.: PCT/EP07/59455

§ 371 Date: Aug. 21, 2008

(30) Foreign Application Priority Data
Oct. 23, 2006 (DE) 10 2006 049 805.4

(51) Int. Cl. F16L 11/12

(52) U.S. Cl. 138/137; 138/141; 428/36.91

(57) ABSTRACT

A pipe, which comprises the following layers:
I. an exterior layer composed of a moulding composition which comprises at least 40% by weight of a polyamide whose monomer units contain, on average, at least 8 carbon atoms,
III. an intermediate layer composed of a moulding composition which comprises the following components:
   a) from 70 to 99% by weight of polyamide, selected from PA6, PA66, PA6/66 and mixtures thereof and
   b) from 1 to 30% by weight of plasticizer, where the moulding composition comprises no impact modifier, and
V. an interior layer composed of a moulding composition which comprises at least 40% by weight of a polyamide whose monomer units contain, on average, at least 8 carbon atoms,
   where
a) the exterior diameter of the pipe is in the range from 6 to 20 mm,
b) the wall thickness is in the range from 1.0 to 2.0 mm and
c) the thickness of the polypropylene layer is from 25 to 75% of the wall thickness,
   is used as air-brake line which can be produced at low cost and which has high bursting strength and good low-temperature impact resistance.

The invention relates to a pipe which is intended for an air-brake line and which comprises an interior and exterior layer composed of a higher polyamide, and comprises an intermediate layer composed of a plasticized PA6 or PA66.

Air-brake systems are often used in heavy-duty vehicles, e.g. in tractor units and the like. In these systems, compressed air conducted through a pipe activates the braking system.

Currently, air-brake lines are mainly manufactured from single-layer PA11- or PA 12-pipes; there are also multilayer solutions using textile reinforcement with the intention of achieving high bursting pressure with good flexibility. In regions with a low level of mechanical and chemical requirements, systems based on polyurethane are mainly used. Particular mention may be made here of the market for semitrailers and the market for replacement parts. These systems cost less than systems based on PA11 or PA12, but have significant disadvantages in mechanical strength and chemicals resistance.

Higher polyamides, such as PA612, PA11 or PA12 are resistant to stress cracking, and resistant to exposure to fuels, oils and water. They are moreover less susceptible than PA6 to stress cracking caused by zinc chloride. However, they are expensive. Intensive work is underway on low-cost alternatives, in order to respond to the price pressure in the market.

DE-A-101 37 863 describes one technical solution for an air-brake line; it is composed of a pipe with the layer sequence PA11 or PA12/adhesion promoter/impact modified PA6 or PA66; attached to this system, if appropriate, there is also a further adhesion-promoter layer and a concluding layer composed of PA11 or PA12. The layer sequence in the pipe of DE-A-101 37 863 can be PA612/impact-modified PA6 or PA66/PA612.

However, full bursting-pressure potential cannot be achieved, in particular at elevated temperatures, when using impact-modified PA6 and, respectively, PA66. Furthermore, use of an impact modifier is often found to reduce the ageing resistance in PA6 and PA66, which is in any case smaller than that of PA11 or PA12.

The object of the present invention consists in eliminating the abovementioned disadvantages and in particular in providing a low-cost pipe which meets the requirements placed upon an air-brake line with regard to resistance to chemicals, engine oils, zinc chloride and road salt, and which has high bursting strength even at an elevated temperature, good low-temperature impact resistance, and good ageing resistance.

This object has been achieved with the aid of a pipe which comprises the following layers:
I. an exterior layer composed of a moulding composition which comprises at least 40% by weight, at least 45% by weight, at least 50% by weight, at least 55% by weight, or at least 60% by weight, of a polyamide whose monomer units contain, on average, at least 8, at least 9, or at least 10, carbon atoms,
II. if appropriate, a layer composed of an adhesion-promoting moulding composition,
III. an intermediate layer composed of a moulding composition which comprises the following components:
   a) from 70 to 99% by weight, preferably from 75 to 98% by weight, and particularly preferably from 78 to 96% by weight, of polyamide, selected from PA6, PA66, PA6/66 and mixtures thereof and
   b) from 1 to 30% by weight, preferably from 2 to 25% by weight, and particularly preferably from 4 to 22% by weight, of plasticizer, where the moulding composition comprises no impact modifier, and
IV. if appropriate, a layer composed of an adhesion-promoting moulding composition, and
V. an interior layer composed of a moulding composition corresponding to that of the layer I,
   where these layers preferably follow each other directly.

The exterior diameter of the pipe is in the range from 6 to 20 mm and preferably in the range from 7 to 16 mm, while the wall thickness can be from 1.0 to 2.0 mm. The thickness of the layer III here is from 25 to 75%, preferably from 30 to 65%, and particularly preferably from 35 to 60%, of the wall thickness, while the thickness of the layer II and, respectively, IV is in each case from 0.02 to 0.2 mm, preferably from 0.04 to 0.16 mm, and particularly preferably from 0.06 to 0.14 mm.

The polyamide of the layer I and, respectively, V can be prepared from a combination of diamine and dicarboxylic acid, from an ω-aminocarboxylic acid, or from the corresponding lactam. The co-aminocarboxylic acid or the lactam here contains at least 8, at least 9, or at least 10 carbon atoms. In the case of mixtures of lactams, the value here is the arithmetic average. In the case of a combination of diamine and dicarboxylic acid, the arithmetic average of the carbon atoms of diamine and dicarboxylic acid has to be at least 8, at least 9, or at least 10. Examples of suitable polyamides are: PA610 (which can be prepared from hexamethylenediamine [6 carbon atoms] and sebacic acid [10 carbon atoms], the average number of carbon atoms in the monomer units here therefore being 8), PA88 (which can be prepared from octamethylenediamine and 1,8-octanedioic acid), PA8 (which can be prepared from caprylolactam), PA612, PA810, PA108, PA9, PA614, PA812, PA128, PA1010, PA10, PA814, PA148, PA1012, PA11, PA1014, PA1212 and PA12. The preparation of the polyamides is prior art. It is also possible, of course, to use copolyamides based thereon, and if desired concomitant use can also be made of monomers such as caprolactam, with the proviso that the average of the number of carbon atoms complies with the abovementioned condition.

The polyamide can also be a polyetheresteramide or a polyetheramide. Polyetheramides are in principle known, e.g. from DE-A 30 06 961. They contain, as comonomer, a polyetherdiamine. Suitable polyetherdiamines are obtainable via conversion of the corresponding polyetherdiols via reductive amination or coupling to acrylonitrile followed by hydrogenation (e.g. EP-A-0 434 244; EP-A-0 296 852). Their number-average molecular weight is generally from 230 to 4000; their polyetheramide content is preferably from 5 to 50% by weight.

Polyetherdiamines derived from propylene glycol are commercially available from Huntsman as JEFFAMIN® D grades. In principle, other materials with good suitability are polyetherdiamines derived from 1,4-butanediol or 1,3-butanediol, or mixed-structure polyetherdiamines, for example with random or blockwise distribution of the units deriving from the diols. It is also possible to use mixtures of different polyamides, with the proviso that compatibility is sufficient. The person skilled in the art is aware of compatible polyamide combinations, and combinations which may be listed here by way of example are PA12/PA1012, PA12/PA1212, PA612/PA12, PA613/PA12, PA1014/PA12 and PA610/PA12. In case of doubt, routine experiments can be used to determine compatible combinations.

The polyamide can have an excess of amino end groups, and this generally derives from the fact that a diamine has been used as molecular-weight regulator during the preparation process. The excess of amino end groups can also be established via mixing of a polyamide with low amino group content and of a polyamide with high amino group content. The ratio of amino end groups to carboxy end groups can be at least 51:49, preferably at least 55:45, particularly preferably at least 60:40 and with particular preference at least 70:30.

Alongside polyamide, other components can also be present in the moulding composition of the layer according to I, examples being impact modifiers, other thermoplastics, plasticizers, and other conventional additives. The only requirement is that the polyamide forms the matrix of the moulding composition. Examples of other thermoplastics that can be used are other polyamides, PA6 for example, in amounts lower than that of the polyamide used according to the claims.

The moulding composition can also comprise relatively small amounts of additives which are needed for establishing certain properties. Examples of these are pigments or fillers, such as carbon black, titanium dioxide, zinc sulphide, silicates or carbonates, processing aids, such as waxes, zinc stearate or calcium stearate, flame retardants, glass fibres, antioxidants, UV stabilizers, and additives which give the product antielectrostatic properties or electrical conductivity, e.g. carbon fibres, graphite fibrils, stainless-steel fibres, and, respectively, conductive carbon black.

The moulding compositions of the layers I and V can differ in the nature of the polyamide, and in the nature and amount of the other components. However, it is preferable that the two moulding compositions are identical, since then the two layers can be fed from a single extruder.

The moulding composition of the layer III must comprise plasticizers. Plasticizers and their use in polyamides are known. A general overview of plasticizers suitable for polyamides can be found in Gächter/Müller, Kunststoffadditive [Plastics additives], C. Hanser Verlag, 2^{nd} edition, p. 296.

Examples of conventional compounds suitable as plasticizers are esters of p-hydroxybenzoic acid having from 2 to 20 carbon atoms in the alcohol component, or amides of arylsulphonic acids having from 2 to 12 carbon atoms in the amine component, preferably amides of benzenesulphonic acid.

Among plasticizers that can be used are ethyl p-hydroxybenzoate, octyl p-hydroxybenzoate, isohexadecyl p-hydroxybenzoate, N-n-octyltoluenesulphonamide, N-n-butylbenzenesulphonamide (BBSA) or N-2-ethylhexylbenzenesulphonamide.

Another plasticizer that can be used is a phosphorus-containing flame retardant, for example a phosphate or phosphonate, e.g. diphenyl cresyl phosphate.

The moulding composition of the layer III can moreover comprise conventional additives, e.g. processing aids or stabilizers.

PA6 is prepared via ring-opening polymerization of caprolactam.

PA66 is prepared via polycondensation of hexamethylenediamine and adipic acid. It, like PA6, is commercially available in a wide variety of grades.

PA6/66 is a copolycondensate derived from the monomers caprolactam, hexamethylenediamine and adipic acid.

The nature of the adhesion promoter of the layers II and IV is non-critical. Any adhesion promoter can be used which bonds layers I and III and, respectively, V and III sufficiently securely to one another, so that they do not delaminate during production or during subsequent use. In the simplest case, the adhesion promoter is a polypropylene which contains anhydride groups, these being introduced in a known manner via thermal or free-radical reaction of the polypropylene with an unsaturated dicarboxylic anhydride, with an unsaturated dicarboxylic acid or with an unsaturated dicarboxylic acid monoalkyl ester at a concentration which is sufficient for good coupling to the polyamide of the adjacent layer. Examples of suitable reagents are maleic acid, maleic anhydride, monobutyl maleate, fumaric acid, aconitic acid, citraconic acid or itaconic anhydride. It is preferable that from 0.1 to 4% by weight of an unsaturated anhydride is grafted in this way onto the polypropylene. According to the prior art, the unsaturated dicarboxylic anhydride or its precursor can also be applied by grafting together with a further unsaturated monomer, such as styrene, α-methylstyrene or indene. However, the adhesion promoter can also be a blend composed of this type of polypropylene bearing anhydride groups and a polyamide.

As an alternative to this, the adhesion promoter can also be a polyamide which is compatible with the polyamides of the layer III and the layer I and, respectively, V, for example PA610 or PA612.

In a further embodiment, the adhesion promoter is a blend composed of two different polyamides, of which one is compatible with the material of the layer III and the other is compatible with the material of the layer I and, respectively, V; examples here are blends composed of PA6 and PA 12 or blends composed of PA6 and PA612. If these polymers are incompatible with one another, preparation of the blend at conventional processing temperatures, giving a physical mixture, achieves adequate adhesion-promoting action only within a relatively narrow range of compositions. Better results are obtained if the polyamide blend is prepared under conditions in which the two polyamides react with one another to a certain extent by way of the end groups or by way of transamidation reactions, to give block copolymers. Temperatures above 250° C., preferably above 280° C., and particularly preferably above 300° C. are generally required for this, as also, if appropriate, is the presence of catalysts, such as hypophosphorous acid, dibutyltin oxide, triphenylphosphine or phosphoric acid. It is also possible to start from a polyamide blend prepared initially under conventional processing conditions and then to subject this to solid-phase post-condensation under conditions conventional for polyamides. These are generally temperatures from 140° C. up to about 5 K below the crystalline melting point Tₘ, preferably temperatures from 150° C. up to about 10 K below Tₘ, using reaction times from 2 to 48 hours, preferably from 4 to 36 hours and particularly preferably from 6 to 24 hours. It is particularly advantageous that one of the polyamides contains an excess of amino end groups and that the other polyamide contains an excess of carboxy end groups. Finally, linkage of the components according to a) and c) can also be achieved via addition of a reactive compound which preferably links the polyamide end groups to one another, for example a bisoxazoline, biscarbodiimide, bismaleimide, bisanhydride, diisocyanate, or the corresponding compounds having three or more functional groups.

Another way of rendering the blend components compatible with one another is addition of an effective amount of a compatibilizer, such as a polyamine-polyamide copolymer.

The polyamine-polyamide copolymer is prepared using the following monomers:
a) from 0.5 to 25% by weight, preferably from 1 to 20% by weight and particularly preferably from 1.5 to 16% by weight, based on the polyamine-polyamide copolymer, of a polyamine having at least 4, preferably at least 8 and particularly preferably at least 11, nitrogen atoms and a number-average molar mass Mₙ of at least 146 g/mol, preferably at least 500 g/mol, and particularly preferably at least 800 g/mol, and
b) polyamide-forming monomers, selected from lactams, ω-aminocarboxylic acids and/or equimolar combinations of diamine and dicarboxylic acid.

In one preferred embodiment, the amino group concentration of the polyamine-polyamide copolymer is in the range from 100 to 2500 mmol/kg.

Examples of classes of substance that can be used as polyamine are the following:
polyvinylamines (Römpp Chemie Lexikon [Römpp's chemical encyclopaedia], 9^{th} edition, volume 6, page 4921, Georg Thieme Verlag Stuttgart 1992);
polyamines prepared from alternating polyketones (DE-A 196 54 058);
dendrimers, such as
((H₂N—(CH₂)₃)₂N—(CH₂)₃)₂—N(CH₂)₂—N((CH₂)₂—N((CH₂)₃—NH₂)₂)₂ (DE-A-196 54 179), or
tris(2-aminoethyl)amine, N,N-bis(2-aminoethyl)-N′,N′-bis[2-[bis(2-aminoethyl)amino]ethyl]-1,2-ethanediamine,
3,15-bis(2-aminoethyl)-6,12-bis[2-[bis(2-aminoethyl)amino]ethyl]-9-[bis[2-bis(2-aminoethyl)amino]ethyl]amino]ethyl]-3,6,9,12,15-pentaazaheptadecane-1,17-diamine (J. M. Warakomski, Chem. Mat. 1992, 4, 1000-1004);
linear polyethyleneimines which can be prepared by polymerizing 4,5-dihydro-1,3-oxazoles, followed by hydrolysis (Houben-Weyl, Methoden der Organischen Chemie [Methods of organic chemistry], Volume E20, pp. 1482-1487, Georg Thieme Verlag Stuttgart, 1987);
branched polyethyleneimines obtainable by polymerizing aziridines (Houben-Weyl, Methoden der Organischen Chemie [Methods of organic chemistry], Volume E20, pp. 1482-1487, Georg Thieme Verlag Stuttgart, 1987) and generally having the following distribution of amino groups:
from 25 to 46% of primary amino groups,
from 30 to 45% of secondary amino groups, and
from 16 to 40% of tertiary amino groups.

In the preferred case, the polyamine has a number-average molar mass Mₙ of not more than 20 000 g/mol, particularly preferably not more than 10 000 g/mol, and with particular preference not more than 5000 g/mol.

Lactams and, respectively, ω-aminocarboxylic acids which are used as polyamide-forming monomers contain from 4 to 19 carbon atoms, in particular from 6 to 12 carbon atoms. Particular preference is given to the use of ε-caprolactam, ε-aminocaproic acid, capryllactam, ω-aminocaprylic acid, laurolactam, ω-aminododecanoic acid, and/or ω-aminoundecanoic acid.

Examples of combinations of diamine and dicarboxylic acid are hexamethylenediamine/adipic acid, hexamethylenediamine/dodecanedioic acid, octamethylenediamine/sebacic acid, decamethylenediamine/sebacic acid, decamethylenediamine/dodecanedioic acid, dodecamethylenediamine/dodecanedioic acid, and dodecamethylenediamine/2,6-naphthalenedicarboxylic acid. However, besides these it is also possible to use any other combinations, such as decamethylenediamine/dodecanedioic acid/terephthalic acid, hexamethylenediamine/adipic acid/terephthalic acid, hexamethylenediamine/adipic acid/caprolactam, decamethylenediamine/dodecanedioic acid/co-aminoundecanoic acid, decamethylenediamine/dodecanedioic acid/laurolactam, decamethylenediamine/terephthalic acid/laurolactam, or dodecamethylenediamine/2,6-naphthalenedicarboxylic acid/laurolactam.

The composition of the polyamide fraction in the polyamine-polyamide copolymer can vary within a very wide range, since compatibility with the blend components is evidently determined by other factors and is generally found to be present.

The polyamine-polyamide copolymers can be prepared by various processes. Reference may be made to EP-A-1 216 825 for details.

If requirements for bursting strength are raised to a high level, the pipe can also comprise textile reinforcements according to the prior art. The location of this can either be within one layer or between two layers. From a manufacturing point of view, application of the textile layer to the exterior layer of the pipe with subsequent rubber coating is the simplest technical solution. Rubber that can be used here is either a vulcanizable rubber or a thermoplastic elastomer, e.g. Santopren. Coating with rubber can also take place without application of a textile layer.

The inventive pipe is used as air-brake line, for example in lorries, semitrailers, lorry trailers, or trailer units. The operating pressure at which the lines are operated in lorries is generally up to 12.5 bar, and in semitrailers or trailer units it is 8.5 bar.

The following moulding compositions were used in the examples:
PA: VESTAMID® X7297, an impact-modified, plasticized PA12
HV: A moulding composition composed of 62.13 parts by weight of PA612, 15.93 parts by weight of PA6, 7.97 parts by weight of plasticizer (BBSA), 11.15 parts by weight of impact modifier and 1.22 parts by weight of stabilizers
FM1: Moulding composition composed of 76.46% by weight of PA6 (ULTRAMID® B4), 10% by weight of plasticizer (BBSA), 13% by weight of impact modifiers and 0.54% by weight of stabilizers
FM2: Moulding composition composed of 87.46% by weight of PA6 (ULTRAMID® B5, BASF AG), 12% by weight of plasticizer (BBSA) and 0.54% by weight of stabilizers.

Multilayer pipes corresponding to Comparative Example 1 and Example 1 with exterior diameter of 8 mm and wall thickness of 1 mm were produced on a multilayer pipe plant and were then tested. The details are collated in Table 1. It is seen that according to the invention bursting pressure has been markedly improved for comparable flexibility of the pipes.

TABLE 1
Pipe structures and test results

| | Comparative Example | | Example 1 | |
|---|---|---|---|---|
| 1st layer | 0.15 | mm PA | 0.15 | mm PA |
| 2nd layer | 0.1 | mm HV | 0.1 | mm HV |
| 3rd layer | 0.5 | mm FM1 | 0.5 | mm FM2 |
| 4th layer | 0.1 | mm HV | 0.1 | mm HV |
| 5th layer | 0.15 | mm PA | 0.15 | mm PA |

| | | |
|---|---|---|
| Low-temperature impact | | |
| resistance [fracture ratio] | | |
| fresh from extrusion, to | 0/10 | 0/10 |
| DIN 73378 6.4.6, −40° C. | | |
| fresh from extrusion, to | 0/10 | 0/10 |
| SAE J2260 7.6, −40° C. | | |
| fresh from extrusion, to | 0/10 | 0/10 |
| SAE J844, −40° C. | | |
| Comparative stress to | | |
| SAE J844 [MPa] | | |
| at 23° C. | 31.1 | 34.7 |
| at 100° C. | 13.0 | 14.5 |
| Minimum bending radius | 35 | 35 |
| to SAE J844 [mm] | | |
| Bending properties to | | |
| GME 08100 7.7 | | |
| maximum bending force [N] | 67.4 | 69.2 |
| deflection at maximum | 6.9 | 6.7 |
| bending force [mm] | | |
| bending force at 3.5 mm | 57.5 | 58.5 |
| deflection [N] | | |

1. A pipe, which comprises the following layers:
I. an exterior layer composed of a moulding composition which comprises at least 40% by weight of a polyamide whose monomer units contain, on average, at least 8 carbon atoms,
III. an intermediate layer composed of a moulding composition having no impact modifier which comprises the following components:
a) from 70 to 99% by weight of polyamide, selected from PA6, PA66, PA6/66 and mixtures thereof and
b) from 1 to 30% by weight of plasticizer, and
V. an interior layer composed of a moulding composition which comprises at least 40% by weight of a polyamide whose monomer units contain, on average, at least 8 carbon atoms,
where
a) the exterior diameter of the pipe is in the range from 6 to 20 mm,
b) the wall thickness is in the range from 1.0 to 2.0 mm and
c) the thickness of the intermediate layer is from 25 to 75% of the wall thickness.

2. The pipe according to claim 1,
characterized in that
the layers I and III are bonded to one another via an adhesion-promoter layer II and/or
the layers III and V are bonded to one another via an adhesion-promoter layer IV,
where the thickness of the layers 11 and IV is from 0.02 to 0.2 mm.

3. The pipe according to claim 1,
characterized in that
it is an air-brake line.

4. The pipe according to claim 2,
characterized in that
it is an air-brake line.
